(19) United States
(12) Patent Application Publication
(10) Pub. No.: US 2011/0233915 A1
(43) Pub. Date: Sep. 29, 2011

(54) Multi-purpose elastic bookmark with pocket

(76) Inventors: Brenda Gail Palmer, (US); Michael Joseph Palmer, (US)

(21) Appl. No.: 13/071,701

(22) Filed: Mar. 25, 2011

Related U.S. Application Data
(60) Provisional application No. 61/318,279, filed on Mar. 26, 2010.

(51) Int. Cl. B42D 9/00

(52) U.S. Cl. 281/42

(57) ABSTRACT

Disclosed is a combination pocket and bookmark comprising a length of elastic material folded on one end and stitched to create an open top pocket on a length of a facing side of the elastic material, the second end of the elastic material attached to the back side of a bottom end of the pocket to create a loop, one end of a length of flexible ribbon attached to the elastic material a distance along the loop away from the pocket, the loop snugly wrapping around a book cover of a book, the pocket parallel to a spine of the book, the ribbon sufficient in length to be used as a bookmark.

### PRIORITY

This non-provisional patent application claims priority to provisional patent application Application No. 61/318,279, entitled Book-Buddy Elastic Combination Bookmark & Pen Holder, filed on Mar. 26, 2010, which is herein incorporated in full by reference.

### BACKGROUND OF THE INVENTION

The disclosed invention relates to an elastic holder for pens or the like in combination with a bookmark.

A reader often underlines or marks in a book or uses reading glasses when reading a book. It would be handy to have a simple way to store pens/markers/reading glasses with the book. A reader would also find a bookmark useful in marking the pages where he/she had completed reading. A device which combines both of these functions is desirable.

Combination pen holders/bookmarks have been disclosed in prior art, for example, Seth Goldberg, et al., U.S. Pat. No. 7,125,049; Lucinda C. McClosky, U.S. Pat. No. 6,481,367; Fred P. Gonot, Jr. et al., U.S. Pat. No. 4,162,800; Kip H. Dopps, U.S. Pat. No. 5,095,846; Linda S. Leake, U.S. Pat. No. 5,501,171; Douglas E. Rigbey, U.S. Pat. No. 5,881,434. The known devices are complex to construct, are not simple to use, and some may cause damage to the spine of a book or to the pages of a book. For example, U.S. Pat. No. 6,481,367 uses folded pockets to keep the pens in place which does not translate to ease of use.

### SUMMARY OF THE INVENTION

The disclosed invention is directed to a portable, multi-purpose device intended as a companion for attachment to and use with a physical book. The preferred embodiment of the disclosed device has a simple construction. It may be constructed of a single strip of elastic material of a strength and width adapted for the purposes as described herein. Thus, disclosed is a combination pocket and bookmark comprising a length of elastic material folded on one end and stitched to create an open top pocket on a length of the facing side of the elastic material, the second end of the elastic material attached to the back side of a bottom end of the pocket to create a loop, one end of a length of flexible ribbon attached to the elastic material a distance along the loop away from the pocket, the loop snugly wrapping around a book cover of a book, the pocket parallel to a spine of the book, the ribbon sufficient in length to be used as a bookmark. The device is adapted to fit snugly around a book cover for the purpose of holding objects such as pens, pencils, highlighters, markers, eyeglasses, PDA devices, passports, driver's licenses or similar portable items to be readily accessible to the reader. The ribbon may be designed to be themed to particular interests of the user such as occupations, hobbies, sports teams or like personal preferences. The device may be inserted over the inside of a book cover such that the pocket faces up.

It is an objective of the invention to provide an aid to readers for easily accessing and storing writing implements and above-mentioned articles when reading a book. The item is easily slipped onto the book cover and can be stretched around a variety of sizes of book covers. Additionally, the disclosed device is adapted to be stretched across a closed book.

A further objective of the invention is to provide a means of snugly holding the above-mentioned items while allowing easy and quick removal from the pocket. Because of the elastic quality of the apparatus, items can be both securely stored in the pocket and easily be slipped in and out of the pocket. Also, due to the elastic quality of the device, it can be wrapped around the book not just the book cover, for storage of the book and to protect the spine of the book and its pages.

A further objective of the invention is to make the disclosed invention adjustable over a wide range of books by making it adjustable by snapping it together in at least three positions and allowing the elastic quality of the band to work in holding it on any size book.

### BRIEF DESCRIPTION OF THE DRAWINGS

FIG. 1 is a perspective view of a preferred embodiment of the disclosed device inserted over a book cover.

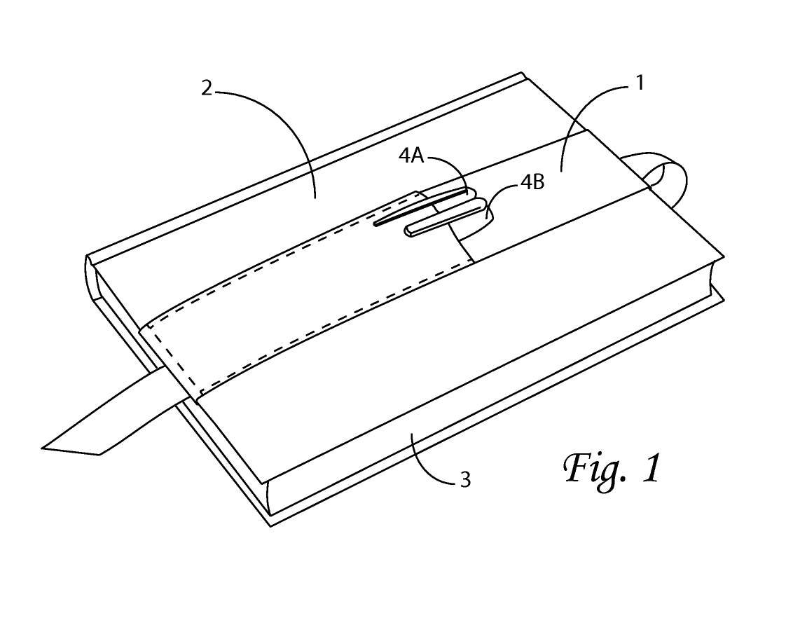

FIG. 2 is a perspective view of the disclosed device when not inserted over a book cover.

FIG. 3 is a perspective view of an alternative embodiment of the disclosed device having a wider pocket.

FIG. 4 is a perspective view of an alternative embodiment of the disclosed device having two pockets.

FIG. 5 is a perspective view or an alternative embodiment of the disclosed device having snaps to make it adjustable through a wide range of books.

### DETAILED DESCRIPTION OF THE DRAWINGS

Referring to the drawings, the multipurpose (pocket plus bookmark) device of the invention is referred to generally as the device 1. The device 1 has been wrapped around the cover 2 of a book 3, and the book 3 has been closed. Two writing instruments 4a, 4b, which can be pens, pencils, markers, or other such implements, have been stored snuggly in the elastic pocket. A ribbon 5 is attached near the top of the device 1.

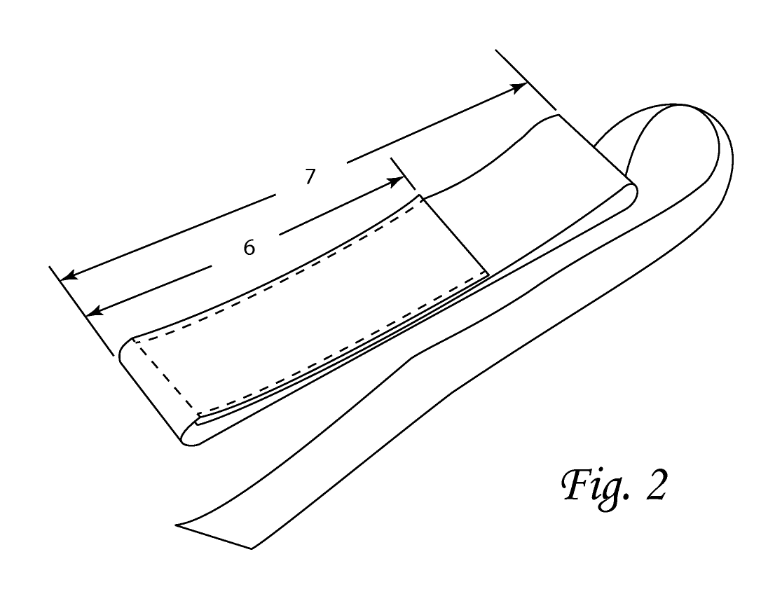

Referring to FIG. 2, the stitching or attachment of the pocket requires one length of elastic to form. It is formed when the overlap is enough to have 4a and 4b to fit, sewn or attached down the length of the overlap, 6, and sewn or attached perpendicular to the length, 7.

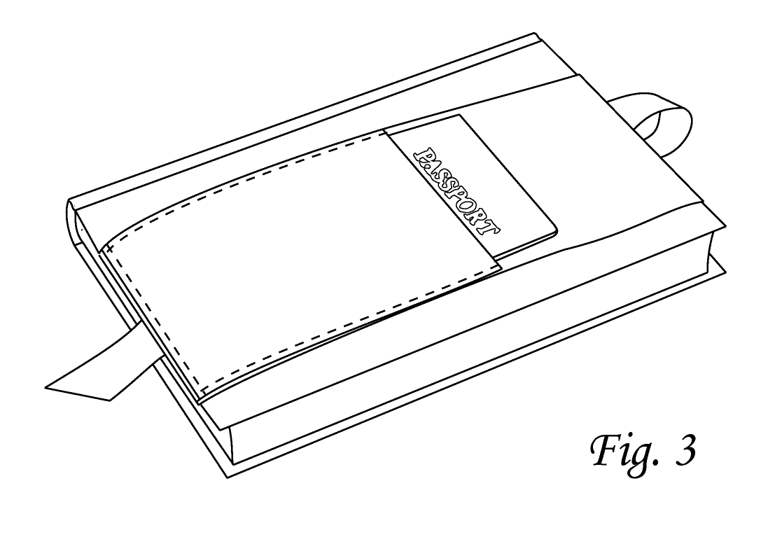

Referring to FIG. 3, shown is an alternative embodiment where the strip of elastic material is wide enough such that the pocket that is formed can be used to store larger items such as a passport, cell phone, an MP3 player, in addition to a pen or marker.

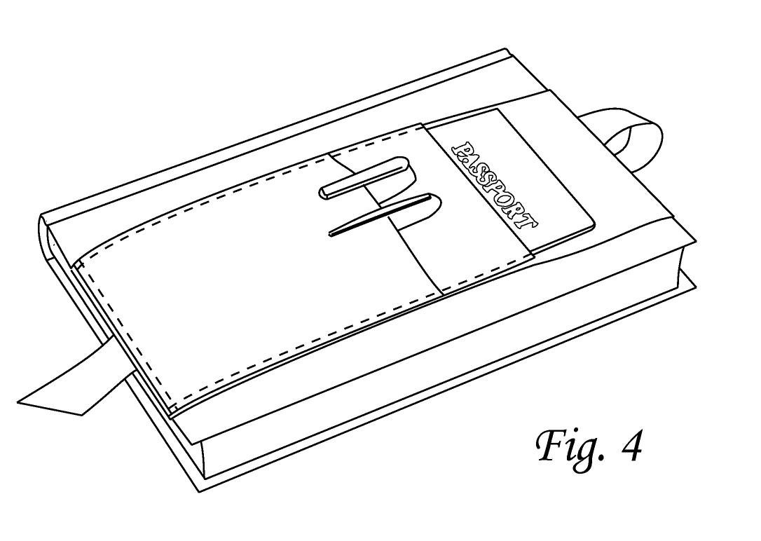

Referring to FIG. 4, shown is an alternative embodiment comprising two pockets for carrying a passport, a driver's license, or the like, in addition to a pen or marker.

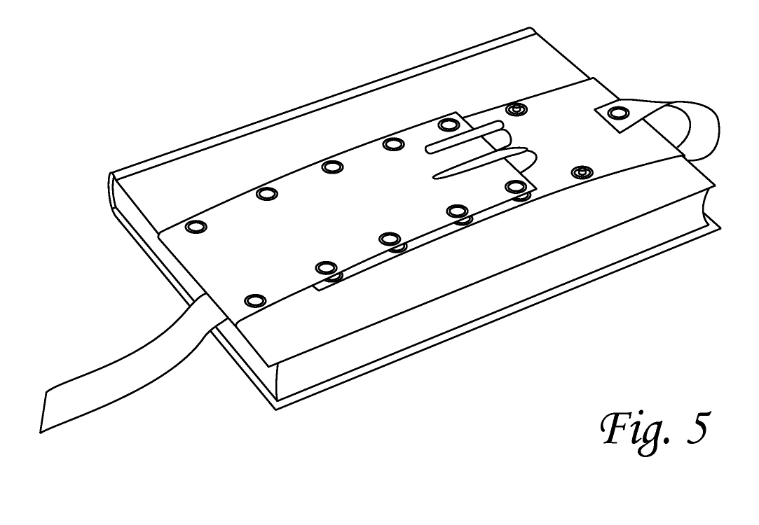

Referring to FIG. 5, shown is an alternative embodiment where it is adjustable using a series of snaps.

We claim:

1. A combination pocket and bookmark comprising a length of elastic material folded on one end and stitched to create an open top pocket on a length of the facing side of the elastic material, the second end of the elastic material attached to a back side of the pocket to create a loop, one end of a length of flexible ribbon attached to the elastic material a distance along the loop away from the pocket, the loop snugly wrapping around a book cover of a book, the pocket parallel to a spine of the book, the ribbon sufficient in length to be used as a bookmark.

2. The combination pocket and bookmark per claim 1 wherein the elastic material comprises a width such that the pocket is suitable for storing a passport without bending the passport.

3. The combination pocket and bookmark per claim 1 wherein the loop is adapted to fit snugly over a closed book without destroying the elastic material or the book cover.

4. A combination pocket and bookmark comprising a length of elastic material formed into a loop having a front face and a back face, the front face of the loop comprising two open top pockets one above the other along a length of the front face of the loop, at least one pocket of sufficient width to hold a passport without bending the passport, one end of a flexible ribbon attached to the loop a distance away from the pockets, the length of the ribbon sufficient to be used as a bookmark.

5. A combination pocket and bookmark comprising a length of elastic material comprising a front face, a back face, a first end and second end, a plurality of spaced male snap portions along a portion of the length of material on the front face of the first end, the male snap portions facing out, a plurality of spaced female snap portions along a portion of the length of material on the front face of the second end, the, the second end folder over the front face of the first end to create an overlap area and a loop, the snaps closed to create an open top pocket in the overlap area, one end of a length of flexible ribbon attached to the elastic material a distance along the loop away from the pocket, the loop snugly wrapping around a book cover of a book, the pocket parallel to a spine of the book, the ribbon sufficient in length to be used as a bookmark.
